(19) United States
(12) Patent Application Publication
(10) Pub. No.: US 2012/0307355 A1
(43) Pub. Date: Dec. 6, 2012

(54) MICROSCOPE SLIDE HEATING AND MOUNTING APPARATUS AND METHOD OF OPERATION THEREFOR

(75) Inventors: Rodrigo E. Teixeira, Madison, AL (US); Donald W. Shelton, Kelso, TN (US)

(73) Assignee: Streamline Automation, LLC, Huntsville, AL (US)

(21) Appl. No.: 13/151,225

(22) Filed: Jun. 1, 2011

(51) Int. Cl. G02B 21/26; G01N 1/44; G02B 21/34; G02B 21/30

(52) U.S. Cl. 359/395; 356/36

(57) ABSTRACT

The invention comprises a slide preparation apparatus and method of operation therefor for aiding in microscope slide preparation. The slide preparation apparatus includes an inclined plane surface configured to support a microscope slide assembly at an angle that ergonomically facilitates delivery of a fluid sample to an upper edge of a cover slip of the microscope slide assembly, which allows gravity to aid fluid delivery a microscope slide. Preferably, the slide preparation apparatus is heated and/or temperature controlled to reduce viscosity of the sampled fluid, which enables the fluid to flow between the microscope slide and the cover slip.

### TECHNICAL FIELD OF THE INVENTION

The present invention relates to the field of microscope slides.

### BACKGROUND OF THE INVENTION

Specimens are mounted on glass slides between a microscope stage and the microscope objective to aid in viewing of the specimens.

### Microscope Slide Preparation

The preparation or mounting of specimens on microscope slides is often critical for successful viewing. Several mounting approaches are reviewed herein.

### Dry Mount

In a dry mount, the sample is simply placed onto the slide. A cover is optionally placed on top of the sample to protect the specimen, to protect the microscope's objective, and to keep the specimen still and pressed flat. Dry mounting is used for viewing specimens like pollen, feathers, and hairs.

### Wet Mount

In a wet mount, the sample or specimen is placed in a drop of water or other liquid held between the slide and the cover slip by surface tension. This method is used, for example, to view microscopic organisms that grow in pond water or other liquid media, especially when studying their movement and behavior. It is also used to examine physiological liquids like blood, urine, and saliva. Creation of air bubbles in wet mounting systems interfere with viewing of the sample, movement of the organism, and quantitative optical analysis of the sample.

### Prepared Mount

For pathological and biological research, the specimen usually undergoes a complex preparation that, for example, involves cutting into very thin sections, fixing of the sample, removing water, and staining. As part of this process the specimen optionally ends up attached to the slide and is referred to herein as a prepared mount.

### DESCRIPTION OF THE RELATED ART

Patents related to the current invention are summarized here.

### Heated Rack

M. Grover, et.al., “Apparatus and Method for Heating Microscope Slides”, U.S. Pat. No. 6,133,548 (Oct. 17, 2000) describe a vertically upstanding housing having an internally mounted rack structure of horizontal shelves for receiving and heating via conduction microscope slides.

### Air Drying

D. Gao, et.al., “Apparatus for Drying Blood Smear Slides”, U.S. Pat. No. 5,766,549 (Jun. 16, 1998) describe an apparatus for drying a succession of microscope slides including a belt transport system and means for directing heated air to an underside of the microscope slides.

### Thermal Cycling

G. Nuovo, et.al., “In Situ Polymerase Chain Reaction”, U.S. Pat. No. 5,538,871 (Jul. 23, 1996) describe an apparatus for thermal cycling, via use of a thermal cycle sample block, microscope slides to enhance the method of in-situ polymerase chain reaction.

### Centrifuge Preparation

L. Clarke, et.al., “Microscope Slide Centrifuge”, U.S. Pat. No. 4,031,852 (Jun. 28, 1977) describe a microscope slide centrifuge for spinning a slide in preparation of blood films for microscope examination including a platen suitable for accepting a microscope slide with a flat surface perpendicular a spin axis of the centrifuge.

J. Boeckel, et.al., “Centrifuge Rotor Apparatus for Preparing Particle Spreads”, U.S. Pat. No. 4,423,699 (Jan. 3, 1984) describe use of a centrifuge rotor for facilitating preparation of cell dispersions on microscope slides, where a slide is centrifugally sedimented in a centrifugation process.

### Problem

There exists a problem in the art of loading a viscous sample onto a microscope slide for microscope analysis without alteration of the sample.

### SUMMARY OF THE INVENTION

The invention comprises a microscope slide mount and method of operation therefor.

### BRIEF DESCRIPTION OF THE DRAWINGS

A more complete understanding of the present invention is derived by referring to the detailed description and claims when considered in connection with the Figures, wherein like reference numbers refer to similar items throughout the Figures.

FIG. 1 provides a block diagram of a method of slide based analysis;

FIG. 2 is a perspective view of a microscope slide preparation apparatus;

FIG. 3 provides a cross-sectional view of a microscope slide preparation apparatus;

FIG. 4 is a sectional view of a slide holding apparatus; and

FIG. 5 illustrates an adjustable angle slide preparation apparatus at a first, FIG. 5A, and second, FIG. 5B, angle.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

The invention comprises an apparatus for aiding in microscope slide preparation and a method of use thereof.

In one embodiment, a microscope preparation apparatus holds a microscope slide or a microscope slide assembly on an inclined plane. Herein, a microscope slide assembly refers to the microscope slide in combination with a cover slip separated from the microscope slide by a spacer.

Holding the microscope slide assembly at an angle facilitates placement of a viscous sample between the microscope slide and a cover slip in at least two ways. First, the holding of the microscope slide at an angle ergonomically facilitates delivery of a fluid sample to an upper edge of the cover slip. Second, fluid delivery between the inclined microscope slide and cover slip is aided by gravity when the microscope slide assembly is mounted at an angle. The angled microscope mounting apparatus is further described, infra.

In another embodiment, the microscope slide assembly, microscope slide, and/or cover slip is heated to a temperature above room temperature. Optionally, the heating apparatus is also functional as the holding apparatus, such as described infra. For example, the inclined plane holding the microscope slide or microscope slide assembly is heated. Heating the microscope slide and/or the cover slip facilitates delivery of a fluid sample between the microscope slide and cover slip by reducing viscosity of the fluid. For example, a viscous fluid does not readily flow between a microscope slide and a cover slip. However, heating the viscous fluid lowers the viscosity of the fluid, which enables the fluid to flow between the microscope slide and the cover slip. The heated microscope slide mounting apparatus is further described, infra.

Herein an x-, y-, z-axes system is used for description, where the x/y plane is horizontal and the z-axis runs perpendicular to the x/y plane and is aligned with gravity.

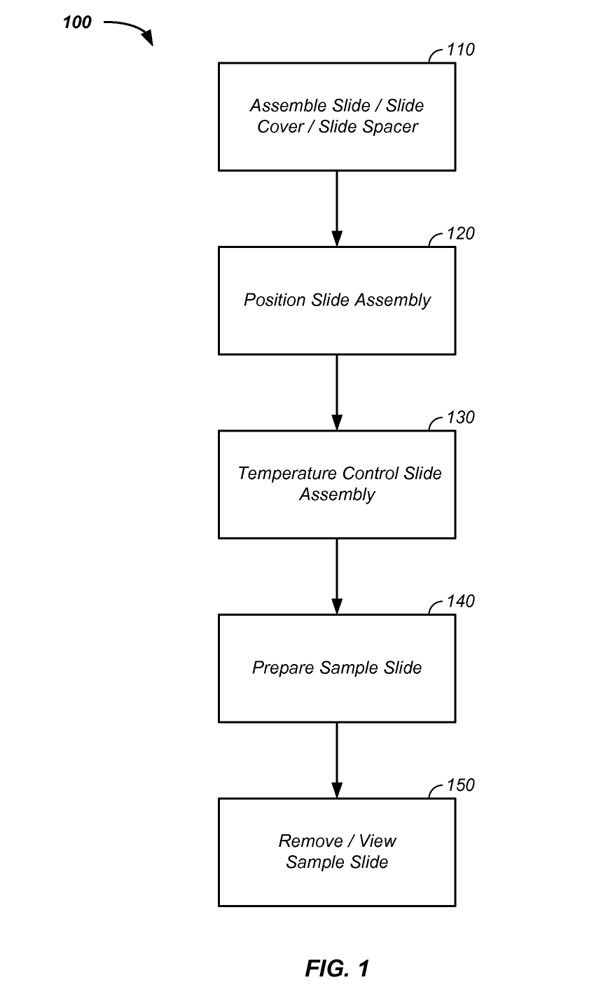

Referring now to FIG. 1, a method of preparation and analysis 100 of a microscope slide 310 is provided. In a first process 110, a microscope slide assembly 316 is prepared by assembly of a microscope slide 310 with an optional spacer 312 and/or a cover slip 314. In a second process 120, the resulting microscope slide assembly is positioned onto the slide preparation holder 200. In a third process 130, the microscope slide assembly 316 is heated and/or temperature controlled. In a fourth process 140, a sample slide is prepared by placing the fluid sample within a cavity between the slide 310 and cover slip 314 in the microscope slide assembly 316. In a fifth process, the microscope slide assembly holding the fluid sample or sample slide is removed from the slide mount and/or is analyzed, such as by viewing with a microscope.

### Microscope Slide

Herein, the microscope slide assembly 316 is further described. A microscope slide 310 is a flat support material for holding a sample for examination under a microscope. Typically, the sample is placed, secured, or mounted onto the slide 310 and the resulting mounted sample is placed within the microscope's field of view for analysis. Microscope slides 310 are optionally used together with a cover glass, a smaller sheet of glass, or a thinner sheet of glass, which are collectively referred to as a cover slip 314. The cover slip 314 is placed over the microscope slide 310 to form a cavity for the specimen. A spacer 312 is optionally used to provide a small and relatively fixed distance between the microscope slide 310 and the cover slip 314. Optionally, slide assembly 316 is held in place on the microscope's stage by slide clips or slide clamps.

Herein, for clarity, the microscope slide assembly 316 is used to describe the invention, without limiting the invention. It is noted that the microscope slide 310, spacer 312, and/or cover slip are optionally used in place of the microscope slide assembly 316.

### Slide Material

Typically, a microscope slide 310 is a thin, flat piece of glass, such as soda lime glass or borosilicate glass. However, many types of microscope slide materials are optionally used, such as specialty plastics, quartz, sapphire slides, or an optically transparent material. The cover slip 314 is optionally composed of any transparent material, such as a glass. Slides 310 are typically made of common glass.

### Slide Dimensions

Typically, the microscope slide 310 is a thin, flat piece of glass about three inches long and about one inch wide. A range of other sizes of slides 310 are optionally available, such as about 75×50 mm for geological use, about 46×27 mm for petrographic studies, and about 48×28 mm for thin section slides. Herein, the microscope slide 310 dimensions include slides from about one-half inch to five inches long and from about one-quarter inch to three inches wide.

### Slide Preparation Apparatus

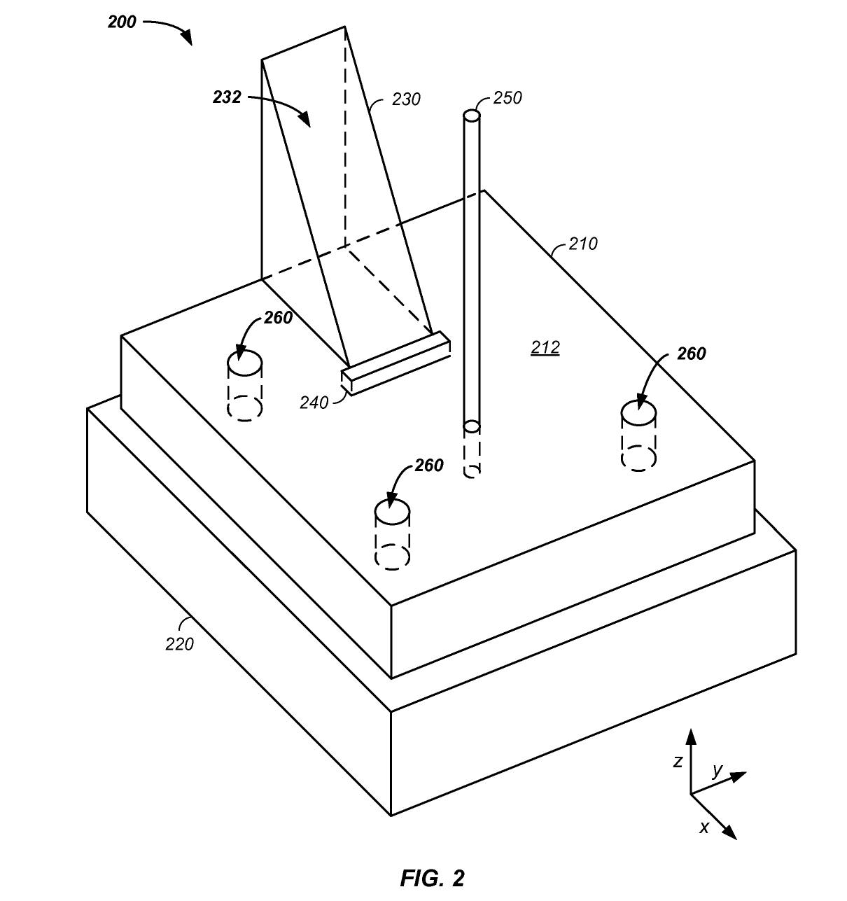

Referring now to FIG. 2, a slide preparation apparatus 200 is described.

In a first example, a base block 210 is placed on a base heater 220 configured to heat the base block 210. As illustrated, the base block 210 includes an upper surface 212. An inclined slide mount 230 is thermally connected to the base block 210. For example, the inclined slide mount 230 is positioned on the base block or is integrated with the base block. In use, the base heater 220 heats the base block 210, which conductively heats the inclined slide mount 230.

In a second example, the inclined slide mount is heated directly without use of one or both of the base block 210 and base heater 220, described infra.

In either example, the inclined slide mount 230 is configured with an upper inclined surface 232 to hold the microscope slide assembly 316. The dimensions of the upper inclined surface 232 optionally match or are larger than any of the slide dimensions, described supra. Herein, an optional slide stop 240 aids in preventing the microscope slide assembly from sliding off of the inclined surface 232 of the inclined slide mount 230. The slide stop 240 is further described, infra.

The inclined slide mount 230 may be sized to accommodate one microscope slide assembly 316, or optionally more than one microscope slide assembly 316. Optionally a plurality of inclined slide mounts 230 may be attached to the base block 210.

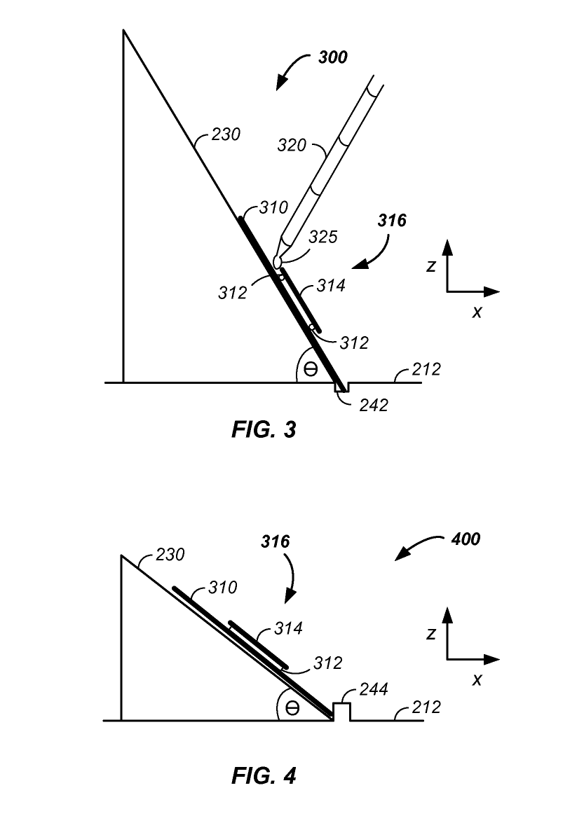

Referring now to FIG. 3, a cross-sectional view 300 of the slide preparation apparatus 200 is used to illustrate mounting the sample into the cavity of the microscope slide assembly 316, such as with a pipette 320 delivering a fluid 325. The fluid is delivered at an upper edge of the cover slip 314 and gravity pulls the, now heated or heating fluid, into the cavity between the microscope slide 310 and microscope slide cover 314.

Referring now to FIG. 4, a cross-sectional view of the slide preparation apparatus is illustrated at a second angle theta 400 of an inclined surface 232 of the inclined slide mount 230 holding the microscope slide assembly 316. The angle theta is optionally about 1 to 90 degrees, more preferably about 20 to 70 degrees, and still more preferably about 30, 40, 50, or 60 degrees. The angle theta is also referred to as an angle of inclination, which is the difference between a horizontal plane and a slide mount surface of the inclined slide mount 230.

### Inclined Slide Mount

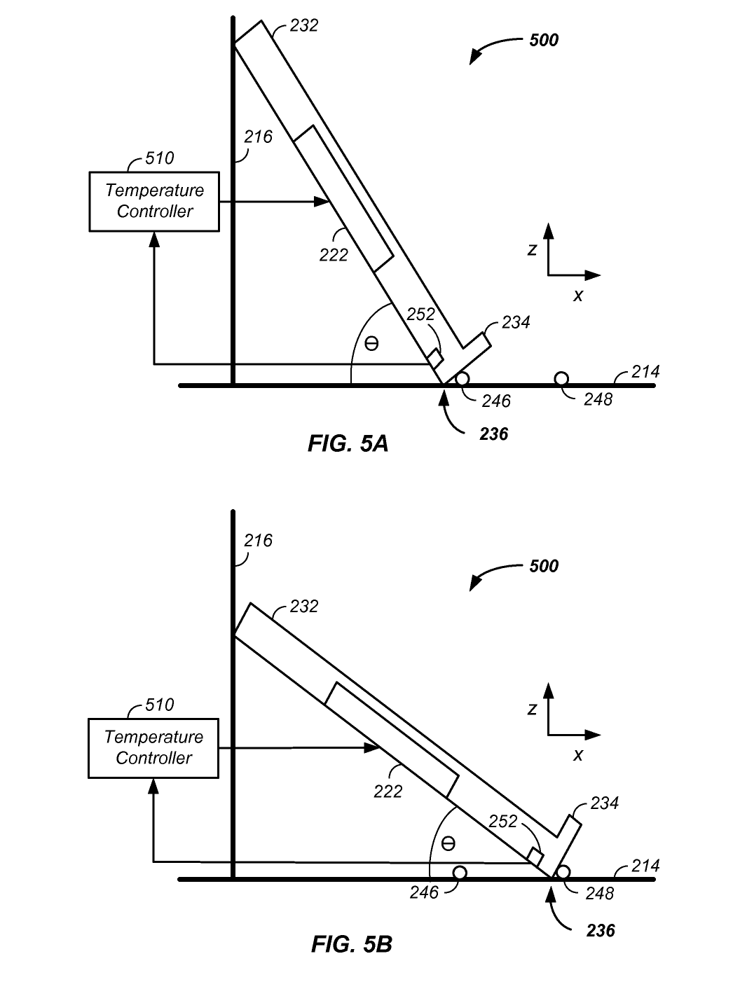

Referring now to FIG. 5A and FIG. 5B, the inclined slide mount 230 is further described. In this example, the inclined slide mount is supported by a base 214, such as a tabletop, a counter, or a supporting surface. The inclined slide mount 230 optionally leans against a support 216, such as a wall, a lab bench backsplash, or a weighted object. In a first case, the inclined slide mount 230 includes a bottom edge or a nonslip element 236 that resists slipping, such as a rough surface or a rubber foot. In a second case, the base 214 includes one or more movement limiters, which are examples of the slide stop 240. Referring still to FIG. 5A, a first movement limiter 246 and a second movement limiter 248 are illustrated. The movement limiter is used to limit slippage and/or to position the inclined slide mount. The movement limiters are affixed to, are partially embedded within, or are cutouts of the base 214. In either case, the nonslip element 236 or movement limiters in combination with the support 216 are used to set the tilt angle theta, θ, of the inclined slide mount 230 relative to the base 214. In another example, a motor mechanically attached to the inclined slide mount is used to control the angle theta. As illustrated in FIG. 5A, the inclined slide mount 230 is optionally a leaning support. Optionally, the bottom end of the inclined slide mount is hinged. In a third case, the inclined front surface of the slide mount is hingedly affixed to the base block, which allows the inclined front surface to vary to any angle theta relative to the base block.

### Slide Stop

The optional slide stop 240 is further described. Referring now to FIG. 2, generally the slide stop 240 is configured to restrict x-axis movement of a lower end of either the inclined slide mount 230 or microscope slide assembly 316.

Examples of slide stops 240 are provided. Referring now to FIG. 3, in a first example, a cutout slide stop 242 is a cutout in either the base block 210 or base 212, which limits x-axis movement of the lower end of the inclined slide mount 230 and/or the microscope slide assembly 316. Referring now to FIG. 4, in a second example, a base extrusion, bump, or bulge 244 is an extension of or an attachment to either the base block 210 or base 212, which limits x-axis movement of the lower end of the inclined slide mount 230 and/or the microscope slide assembly 316. Referring now to FIG. 5A and FIG. 5B, in a third example, one or more limiters, such as the first movement limiter 246 and the second movement limiter 248, limit x-axis movement of the lower end of the inclined slide mount 230 and/or the microscope slide assembly 316. Referring still to FIG. 5A, in a fourth example, a slide mount extrusion, bump, or bulge 234, which is affixed to and/or integrated into the inclined slide mount 230, limits x- and z-axes movement of the microscope slide assembly 316. Referring again to FIG. 5B, in a fifth example, the nonslip element 236 (not illustrated) affixed to and/or embedded in the inclined slide mount 230 limits x-axis movement of the lower end of the microscope slide assembly 316.

### Temperature Sensor

Referring again to FIG. 2, the base block 210 includes an optional temperature sensor 250, such as a thermometer, thermocouple, and/or a thermistor 252. As illustrated in FIG. 2, a thermometer is integrated into the base block 210 and is used to measure the temperature of the base block 210, which controls the temperature of the inclined slide mount 230 configured to hold the microscope slide assembly 316. Combined, the base heater 220 and temperature sensor 250 provide a temperature control to the inclined slide mount 230 configured to hold and heat the microscope slide assembly 316.

### Temperature Control System

Referring now to FIG. 5A, an example of the temperature sensor 250 integrated into the inclined slide mount 230 is described. In one example, an inclined plane heater 222 is affixed to, removeably affixed to, and/or embedded into a portion of the leaning support or inclined slide mount 230. The inclined plane heater heats at least the inclined surface 232 of the inclined slide mount 230. Optionally, a thermistor 252 or other temperature sensor is affixed to, removeably affixed to, and/or embedded into a portion of the leaning support or inclined slide mount 230, such as with about ¼, ½, ¾, 1, 2, or 3 three inches from a portion of the inclined surface 232 in contact with the microscope slide assembly 316 during use. The thermistor 252 or other temperature sensor is electrically attached to a temperature readout device and/or a temperature controller 510. The temperature controller 510 iteratively controls the temperature of the inclined slide mount 230 by controlling the inclined plane heater 222 using input from the thermistor 252 or temperature sensor 250. Heat is transferred from the heating element to the sample via conduction and/or by convection.

Similarly, the temperature sensor 222 is placed in the inclined slide mount 230 or base block 210 and in combination with the temperature controller 510 and a base heater or the inclined plane heater 222 is used in temperature control of the inclined slide mount 230 and/or base block 210.

### Test Tube Mounts

Referring again to FIG. 2, optional apertures, holes, or mounts 260 are cut or cast into the base block 210. In a first case, the mounts 260 are configured to hold a test tube or similar container and are temperature elevated, controlled, and/or stabilized by heat transfer from the base block 210. The test tubes are configured to hold an aliquot of the tested sample or fluid. By pre-elevating or controlling the sample temperature to about the same temperature as the inclined slide mount, such as within about 0.1, 0.5, 1, 2, 3, 4, or 5 degrees centigrade, the viscosity of the sampled fluid does not change when placed onto the microscope slide assembly. Optionally a single temperature controller 510 is used to control temperature of a first interface with the test tube at the test tube mount 260 and to also control temperature at a second interface between the inclined surface 232 and the microscope slide assembly 316.

Several advantages of the preheating system are herein described. First, maintaining the temperature of the sample in the test tube at the same temperature as the inclined surface 232 and/or microscope slide assembly 316:
reduces sampling error inherent in transfer of non-homogenous fluid through a temperature gradient;
reduces formation of bubbles in the sample within the microscope slide assembly 316 resultant from temperature changes, which hinder microscope analysis; and
decreases fluid sample viscosity aiding in placing viscous and/or non-homogeneous fluids into a sample chamber within the microscope slide assembly.

Optionally, the mounts 260 are configured to hold a pipette tip and/or pipette. The control of the pipette tip temperature to the controlled sample temperature again minimizes error, such as those described, supra, for transfer of a sample through a temperature gradient.

Any of the examples or elements provided herein are optionally operable or combinable with any other example or element described herein in any permutation and/or combination.

The particular implementations shown and described are illustrative of the invention and its best mode and are not intended to otherwise limit the scope of the present invention in any way. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus configured for mounting a microscope slide, comprising:
a slide mount comprising:
an inclined front surface configured to support the microscope slide, said front surface comprising an angle of inclination greater than fifteen degrees off of a horizontal plane,
a base block affixed to said slide mount, said base block configured with a heating element interface; and
a mechanical stop configured to restrict horizontal movement of the microscope slide, said mechanical stop proximate a base of said inclined front surface.

2. The apparatus of claim 1, wherein the microscope slide comprises one or more of:
a slide base, comprising an about transparent material;
a cover slip configured for placement on the slide base; and
a spacer configured for providing a spacing distance between the slide base and the cover slip.

3. The apparatus of claim 1, said slide mount further comprising:
a vertical support element, said vertical support element adjustable to set the angle of inclination of said inclined front surface of said slide mount to two or more inclination angles between thirty and eighty degrees off of the horizontal plane.

4. The apparatus of claim 1, further comprising:
a heating element configured within one inch of the microscope slide during use.

5. The apparatus of claim 1, said slide mount hingedly affixed to said base block.

6. The apparatus of claim 1, said heater affixed to said base block, said slide mount proximately contacting said base block.

7. The apparatus of claim 1, said mechanical stop comprising at least one of:
an about horizontal cutout into an upper surface of said base block, during use a bottom edge of the microscope slide configured to set in the horizontal cutout.
a limiter element affixed to an upper surface of base block, said limiter element configured to restrict horizontal movement of the bottom edge of the microscope slide during use.

8. The apparatus of claim 6, further comprising at least one of:
a test tube mount at least partially embedded in said base block; and
a thermometer mount at least partially embedded in said base block.

9. The apparatus of claim 1, further comprising:
a temperature sensor configured to provide a measure of temperature of said slide mount; and
a controller configured to use the measure of temperature in control of said heater.

10. The apparatus of claim 1, said slide mount comprising a width configured to hold at least two of the microscope slides side by side.

11. The apparatus of claim 5, said slide mount configured with a plurality of inclined surfaces for mounting a plurality of the microscope slides.

12. The apparatus of claim 1, further comprising:
an integrated heating element, said integrated heating element attached to said base block heating element interface.

13. A method for preparing a microscope slide, comprising the steps of:
providing a slide mount comprising an inclined front surface at an angle of inclination greater than fifteen degrees off of a horizontal plane;
heating said slide mount with a heater;
supporting the microscope slide on said inclined front surface of said slide mount; and
restricting horizontal movement of the microscope slide with a mechanical stop proximate a base of said inclined front surface.

14. The method of claim 13, said heater integrated into a semi-upright element of said slide mount within one inch of said inclined front surface of said slide mount.

15. The method of claim 13, further comprising:
a base plate, said base plate at least one of:
integrated with said slide mount; and
replaceably attached to said slide mount.

16. The method of claim 15, further comprising the steps of:
placing a test tube in a test tube mount integrated to said base plate; and
heating said test tube, with said heater, to within five degrees of said slide mount.

17. The method of claim 16, said base plate held at least six degrees above room temperature.

18. The method of claim 17, further comprising the step of:
preparing a microscope slide assembly comprising: the microscope slide, a slide cover positioned about parallel to the microscope slide, and a spacer positioned between the microscope slide and the slide cover, the microscope slide, spacer, and slide cover forming a gap therebetween;
transferring via pipette a sample from the test tube to an open upper end of the gap.

19. The method of claim 13, further comprising at least one of the steps of:
preheating a test tube by inserting a bottom end of said test tube into said slide mount, said slide mount configured with a test tube receiving element for receiving the test tube.
preheating a pipette tip by inserting a bottom end of said pipette tip into said slide mount, said slide mount configured with a pipette tip receiving element for receiving the pipette tip.

20. The method of claim 19, further comprising the step of:
actively heating at least one of:
an edge of said test tube receiving element; and
an edge of said pipette tip receiving element.

21. The method of claim 20, further comprising the step of:
manually adjusting the slide mount from a first mechanical stop position to a second mechanical stop position, both said first mechanical stop position and said second mechanical stop position comprising a stopping element integrated with a base plate supporting said slide mount.

22. The method of claim 13, further comprising the step of:
using a motor to adjust the angle of inclination of said inclined front surface of said slide mount.

23. A method for holding a microscope slide, comprising the steps of:
providing a slide mount comprising an inclined front surface at an angle of inclination greater than thirty degrees and less than eighty degrees off of a horizontal plane;
temperature controlling the microscope slide assembly above room temperature using a heater, a temperature sensor affixed to said slide mount, and a controller configured to control said heater with temperature data received from said temperature sensor; and
providing a mechanical stop proximate a bottom end of said inclined front surface, said mechanical stop configured to restrict horizontal movement of a base of the microscope slide.

24. The method of claim 23, further comprising the steps of:
preparing a microscope slide assembly comprising: a microscope slide, a cover slip, and a spacer, the cover slip about parallel to the microscope slide, the cover slip separated from the microscope slide by the spacer;
positioning the microscope slide assembly onto the slide mount; and
preparing a sample by placing a fluid sample between said microscope slide and the cover slip after said step of positioning.
